(19) United States
(12) Patent Application Publication
(10) Pub. No.: US 2007/0072542 A1
(43) Pub. Date: Mar. 29, 2007

(54) Communication system comprising a wireless communication network, a radio broadcasting network and a wireless device which can receive signals from both networks

(75) Inventor: John Haagen, Goteborg (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), STOCKHOLM (SE)

(21) Appl. No.: 10/556,787

(22) PCT Filed: May 13, 2003
(86) PCT No.: PCT/SE03/00787

§ 371 Date: Nov. 14, 2005

(51) Int. Cl. H04Q 7/20

(52) U.S. Cl. 455/3.06; 455/433; 455/404.2; 455/456.1

(57) ABSTRACT

The present invention relates to a communication system comprising wireless telecommunication network, a radio broadcasting network and a wireless telecommunication device, which can receive signals from both of said wireless telecommunication network and radio broadcasting network, said telecommunication network providing position of said wireless device. The communication system comprises means, which based on said position of said wireless device and information from the communication system about radio broadcasting stations, determines the broadcasting network identity.

### TECHNICAL FIELD OF THE INVENTION

The present invention relates to a wireless communication system, such as a mobile or cellular phone system, having a Radio Frequency (RF) receiver.

### BACKGROUND OF THE INVENTION

Presently, some mobile phones, also popularly called cell phones, are provided with a radio receiver. The radio receiver can be attached to or communicate (e.g. through IR, Bluetooth) with the phone (purchased as a separate accessory) or be an integrated part of the phone. This allows a combination of entertainment and communication with same device, i.e. a user can use the mobile phone as a radio and listen to a program when not communicating.

Moreover, modern mobile phones also allow accessing Internet, e.g. using WAP (Wireless Application Protocol), GPRS (General Packet Radio Service) or other similar protocols. The phones are also provided with a large display for retrieving and displaying large amount of information. More sophisticated phones are also provided as PDAs (Personal Digital Assistants) or integrated in a PDA, or the like.

Moreover, more and more information are digitalised and broadcasted through DAB (Digital Audio Broadcasting), which implies that more information can be sent to the receiver. Many radio stations also combine broadcasted material with web-based information, such as contests, song lists (current, previous, coming).

Additionally, mobile location based services are expected to become big business for mobile operators. Firms are reporting that revenues for those services will reach anywhere between $9 billion and $33 billion by 2005. Mobile Internet phones or 3G Smart Phones in use will reach one billion worldwide by 2003. Global mobile data market will be $450 billion by 2010. Access to Internet by 2002-100 million mobile Internet devices. The phenomenal growth of the 3G mobile phone services industry will only peak in 2006-2007. The European (EURO) market for mobile entertainment community portals will be worth [symbol] 14 billion by 2005 and [symbol] 63 billion by 2010. Annual consumer revenues from multimedia messaging services (MMS) will reach approx. $60 billion worldwide in 2007.

The invention according to the best embodiment, as described below, is not disclosed in any known prior art. Closest known techniques may include:

WO 01/54440, which discloses a technique for connecting a dialled B-party number to a data object. The connecting of a B-party number to a specific data object, hereafter referred to as phone-page, will allow an A-party direct access to information that a B-party wishes to display to a calling party. The phone-page resides in a memory in a telecommunications network, or in a memory in a data-communications network connected thereto. The phone-page may have a similar appearance to an Internet web page, but may also take other appearances. The displaying of the phone-page may be made dependent upon the capabilities of the A-party user equipment.

In WO 01/54364, a technique for connecting a unique identifier to a data object is described. The connecting of a unique identifier such as a telephone number or an internet address such as an IPv6 address, to a specific data object, hereafter referred to as phone-page, will allow an A-party direct access to information that a B-party or B-party user equipment wishes to display to a connecting party. The phone-page resides in a memory in a telecommunications or data network. The phone-page may have a similar appearance to an Internet web page, but may also take other appearances. The displaying or processing of the phone-page may be made dependent upon the capabilities of the A-party user equipment.

According to WO 00/22761 a broadcast material delivery architecture provides coordinated inclusion of supplemental materials with delivered broadcast material. A broadcaster broadcasts the broadcast materials to a plurality of users, the broadcast material being divided into a plurality of segments. Also broadcast is program data associated with the plurality of segments. A user terminal receives the broadcast material from the broadcaster and retrieving supplemental materials related to said plurality of segments of said broadcast material. To retrieve the supplemental materials, the program data are provided to a data server, which provides parameters for the supplemental materials to the user terminal. The user terminal uses the parameters to retrieve supplemental materials from one or more databases. The user terminal plays the supplemental materials in conjunction with the broadcast material.

According to WO 00/19662, a media player for playing broadcast material and associated supplemental information includes a receiver configured to receive broadcast material from a broadcast service provider. The broadcast material includes program segments and program data related to one or more of said program segments. The player plays program segments of said received broadcast material on a user's terminal. An information retrieval module forwards an item of program data related to a given one of the program segments to a first server enabling the server to retrieve parameters identifying one or more items of supplemental material for said given program segment. The information retrieval module forwards the parameters to a second server to retrieve supplemental materials from said second server based on the parameters, and provides the supplemental materials to the player for playback with a given program segment of broadcast material

### SUMMARY OF THE INVENTION

The main object of the present invention, in accordance with the preferred embodiment, is to provide a new and surprising combined use of a radio receiver and a mobile communication device, such as a mobile phone.

Other advantages of the invention include increased value of the radio entertainment while providing more revenues from, for example advertisement, sales and airtime. Moreover, radio advertisements can be made more efficient by combining audio and Internet browsing. The solution is also cost efficient.

The invention allows increased direct information to a user and possibilities for interaction by the user. Thus, a combination of the radio entertainment and Internet enhances the user experience. Web-based information can easily be accessed also when being mobile.

For these reasons, a communication system is provided, comprising a wireless telecommunication network, a radio broadcasting network and a wireless telecommunication device. The device can receive signals from both of the wireless telecommunication network and radio broadcasting network. The telecommunication network provides a position of the wireless device. The communication system comprises means, which based on the position of the wireless device and information from the communication system about radio broadcasting stations, determines the broadcasting network identity.

### BRIEF DESCRIPTION OF THE DRAWINGS

In the following, the invention will be further described in a non-limiting way with reference to the accompanying drawings, in which:

FIG. 1 schematically illustrates an embodiment of a network according to one preferred embodiment of the invention,

FIG. 2 illustrates an example for determining a position of a user, and

FIG. 3 is a diagram illustrating alternative communication steps.

### DETAILED DESCRIPTION OF THE EMBODIMENTS

The present invention enables combination of two separate technologies, i.e. mobile wireless communication and radio broadcasting. Through this combination, it is possible to provide new services for the subscribers and thus revenues for both phone operators and radio broadcasting companies.

The invention implies using the frequency information from the radio broadcasting, preferably within FM/AM bands, in combination with the position information to automatically determine which radio station the user is tuned in to. Then, the user can simply access the site of the radio station or another determined destination, e.g. by pressing a key, through WAP/Web access, and acquire desired services or information. The AM radio uses frequencies between about 180 kHz and 1.6 MHz, FM radio ranges from 50 to 150 MHz.

The coverage area of a radio station is usually larger than the cell coverage of a cell based communication network. Cell information, such as position and coverage can therefore be used to determine a position of a cell phone good enough to determine which radio station the user is listening to. Thus, the load on MPS (Mobile Positioning System) can be decreased.

A first preferred embodiment of a communication network 100 according to the present invention is illustrated in FIG. 1. A mobile wireless communication arrangement 110 such as a mobile phone or a mobile computer with ability for wireless telecommunication comprises a phone unit 111. The phone unit can be an ordinary transceiver, e.g. used in one or several of GSM, UMTS (Universal Mobile Telecommunication System), and etc. networks.

In the following, the invention will be described in conjunction with a mobile phone operating in a cellular network. However, it is obvious that other types of communication devices operating in other telecommunication networks having ability to position the phone can also be used.

The communication arrangement 110 further comprises a radio receiver 115 and an Internet browsing arrangement 117. The radio receiver is of an ordinary type arranged for receiving radio signals, e.g. In FM/AM or any another appropriate frequency bands. The radio receiver can be arranged to receive DAB or RDS.

The Internet browser comprises a part of the communication arrangement that sends and receives protocols for accessing information on Internet. Presently, a number of primary types of mobile and wireless applications are available: Microbrowser applications (e.g., WAP), voice Internet applications (e.g., Voice XML), and PDA embedded applications (e.g., Pocket PC, Palm devices, Research in Motion [RIM] devices).

The cellular communication signals are transmitted and received by means of a base station (not shown) antennas 120. The radio transmission is made from a radio station 130. The radio station has or is in communication with a web-server 135.

The following steps, according to FIG. 1, illustrate an example of the communication, broadcasting and information retrieving operations:
a. The radio receiver 115 of the mobile communication unit is tuned to an ordinary FM/AM radio station.
b. A control arrangement 118 (hardware or software based) detects the current radio station frequency, to which the radio receiver 115 is tuned in.
c. The user can then use a command (e.g. a key or menu based) to determine the position of the cell phone, i.e. the cell identity, either from the phone or the network.
d. Then the mobile Internet browser accesses the web site related to the radio station (or other site) using a radio station web finder, and the Internet address of the radio station (or another site address) is fetched from a data storage device (database) 145. The storage device can be implemented in the network or in the cell phone.

In step 2, it is also possible to call an MPS application 140 in the network to retrieve the cell phone position.

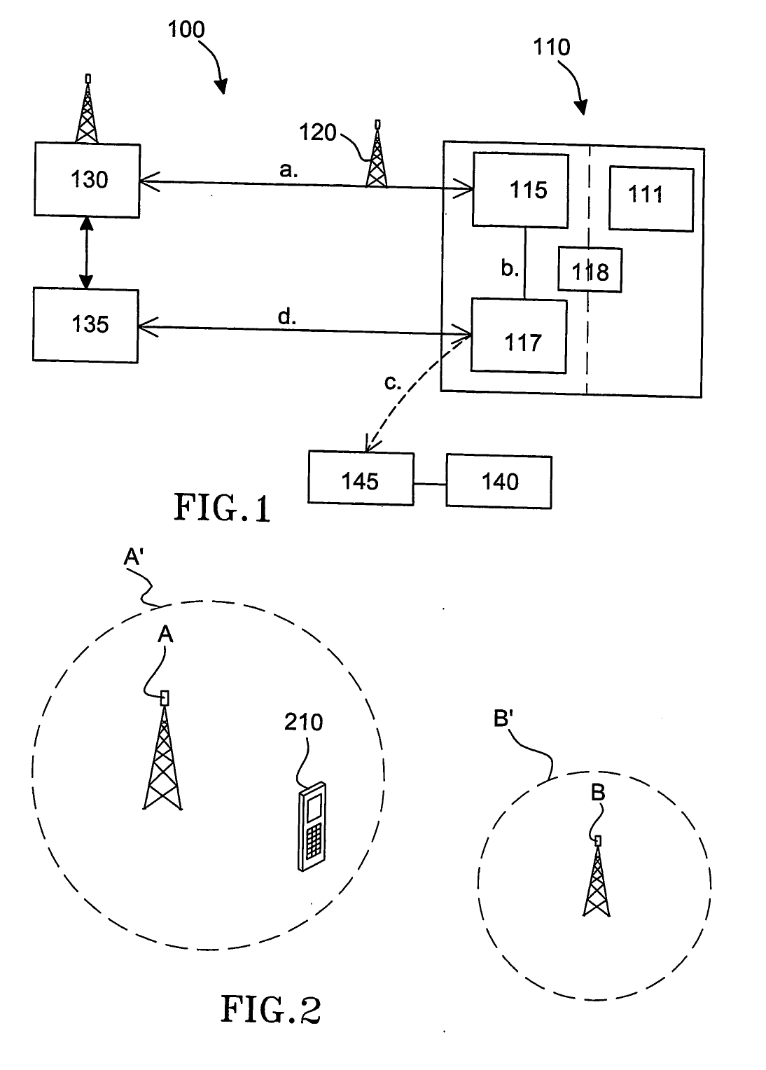

FIG. 2 illustrates how a current radio station tuned in can be found, according to one preferred exemplary embodiment. Two radio stations A and B broadcasting with same radio frequency but different coverage areas A′ and B′ are illustrated. A user having a phone 210 is within the coverage area A′.

By combining the information on the frequency of the FM/AM tuner with information on the current position of the user (phone 210) and a database 145 containing information on each radio station, it can be determined which radio station the user is currently receiving. The information may contain frequency, station position and coverage.

The coverage area (A′, B′) of the radio station is in most cases better than the coverage area of the mobile phone cell. The cell information (position, coverage) can therefore be used to determine a position, which is sufficient enough to determine which radio station the user is listening to.

The cell id is obtained by acquiring information about the communication cell the phone is currently roamed in. The cell id together with the broadcast frequency can then be directly mapped to a broadcast network in the database or the cell id can first be translated to a geographical position e.g. using a GIS (Geographical Information System), which is then used together with the broadcast frequency to map to a broadcast station.

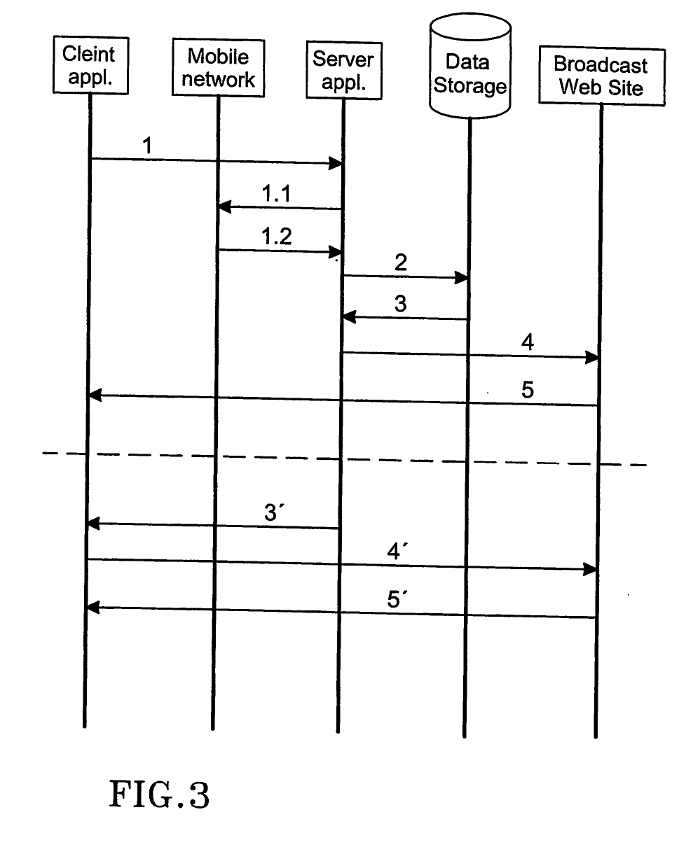

An alternative way is illustrated in diagram of FIG. 3 (the paragraph numbering refers to the step sequences):
1. The Client Application in the mobile phone sends a request for a web page by sending information on current tuned radio frequency (and cell id fetched from the network); the request is sent to a Server Application. The cell phone may also identify itself using, e.g. ISDN number, phone number, SIM number etc.
   1.1 If the cell id is not fetched by the mobile phone, it is obtained from the network by sending an identity, such as the phone number, to the communication network (or other service providers such as positioning services) from the server application;
   1.2 The network returns the position (cell id),
2. The geographical position of the user is determined using the cell id the user is located in and frequency information,
3. The “Radio Station Web Finder (RSWF)” function determines which radio station (broadcast network) the user is tuned in to by combining the information on geographical position (cell id) and the frequency the receiver is tuned in to and searching in a Database containing frequency an geographical information relating to radio stations.
4. The web page request is redirected to the Web site operated by/for the broadcast network.
5. The result from the Broadcast Web Site is sent to the Client Application in the mobile phone.

Alternatively, following steps can substitute steps 3 to 5 (lower part of FIG. 3):
3′. The request from the mobile phone is answered with a redirection address to the web site operated by/for the broadcast network.
4′. The application in the mobile phone sends a request directly to the correct web site.
5′. The reply is sent to the client application

It is also possible to receive the Internet address through RDS data channel or DAB; then there is no need for a database retriever.

Having received the Internet address, the user can then access an Internet site and obtain information, e.g. on the broadcasted program, advertisement, possibility to purchase a record played on the radio, tourist information, play games, Interact with the radio station, etc.

Thus, according to the invention goods or services can be provided from Internet using the phone. Accordingly, the phone can receive Information about the goods or services through the radio broadcasted information or telecommunication transmission. The user can access the network by means of the phone using the access address (URL) arrived through the radio broadcasted information or telecommunication transmission, and obtain Information about the goods or services. If the goods or services are need the user can select them.

The invention also provides a method of selling goods or services, such as CDs or games, to a user of a phone having radiobroadcasting reception ability. The user is provided with information about the goods or service through the radio broadcasting signal or telecommunication signal. The user using the phone (menus) can select the goods/services, and upon the selection, obtain the goods or service. If the purchase is carried out, the user can be billed based on a unique identity information, e.g. a phone number, client number, social security number or credit card number.

Even though, web based information is described in the above examples of preferred embodiments, it is obvious that any structured data type can be sent to and from the mobile communication device and the web sites also relate to data/information providers/operators.

The Invention is not limited to the shown embodiments but can be varied in a number of ways without departing from the scope of the appended claims and the arrangement and the method can be implemented in various ways depending on application, functional units, needs and requirements etc.

1. A communication system for determining a broadcasting station identity from a number of broadcasting stations and providing said identity to a wireless telecommunication device arranged to communicate with a wireless telecommunication network and receive broadcasting signals from said broadcasting stations, said telecommunication network being arranged to provide a position of said wireless device, characterized in
that said communication system comprises:
a storing means for storing information about a radio broadcasting station's identity
means, which based on a position of said wireless telecommunication device received from said telecommunication network and information stored in said storing means, determines said broadcasting station's identity stored in said storing means, and
means in said telecommunication device for accessing a data network through said communication network for obtaining information on said radio broadcasting station based on said position of said wireless telecommunication device.

2. The communication system of claim 1, wherein said communication device is one of a mobile telephone or a computer unit with wireless telecommunication ability.

3. The communication system of claim 1, wherein said positioning is achieved by positioning the communication device in the telecommunication network and with respect to the radio frequency of the received radio broadcasting.

4. The communication system of claim 1, wherein said data network is one of Internet or intranet.

5. The communication system according to claim 1, wherein said system comprises a database containing information on broadcasting radio stations.

6. The communication system of claim 5, wherein said information comprises at least one of frequency band, coverage, radio station position or a communication cell identity.

7. The communication system according to claim 1, comprising a database storing position of radio broadcasting stations.

8. A telecommunication device comprising a combined telecommunication transceiver and a radio broadcasting receiver unit, said device being arranged to receive data from an information source depending on a radio broadcasting station to which said radio broadcasting receiver unit is tuned into,
characterised in
that said device is arranged to be positioned by a telecommunication network and identify a radio broadcasting frequency, providing an identity for said radio broadcasting station, based on which said device receives data from said information source through said telecommunication network.

9. The device of claim 8, wherein said information is transmitted with respect to the position of the device.

10. The device of claim 9, wherein a telecommunication network positions said device.

11. The device of claim 8, wherein said device is provided with Internet access ability to transceive information from said information source.

12. The device of claim 8, wherein said device is a cell-phone.

13. A method of providing information to a wireless telecommunication device, comprising a telecommunication transceiver unit and connected to or communicating with a radio receiver unit arranged to receive signals from a radio broadcasting station, the method comprising arranging said device to receive said information from an information source through a telecommunication network depending on the reception from said radio broadcasting station by identifying a reception frequency and position of said telecommunication transceiver.

14. A method of providing a structured data set to a wireless telecommunication device in a cell of a telecommunication network, comprising a telecommunication transceiver unit and connected to or communicating with a radio receiver unit arranged to receive signals from a radio station, the method comprising the steps of:
a. sending by a Client Application in the wireless telecommunication device a request for said structured data set via said telecommunication network, by sending information on current tuned radio frequency and a cell id;
b. determining a radio station relevant to said radio frequency by combining the information on cell id and the frequency and searching in a storage device containing frequency and geographical information relevant to radio stations,
c. redirecting a structured data request to a data-operator, operated by/for said broadcast network, and
d. providing said wireless telecommunication device with a result from the data operator to the Client Application in said wireless telecommunication device through said telecommunication network.

15. The method of claim 14, further comprising determining a geographical position of said wireless telecommunication device using the cell id relating to said wireless telecommunication device and the frequency information.

16. The method of claim 14, wherein said cell id is fetched from the network.

17. The method of claim 14, further comprising:
a. if the cell id is not fetched by the wireless telecommunication device, obtaining it from the network by sending a number identifying said device to the communication network or other service providers such as positioning services from the server application, and
b. the network returning said position (cell id).

18. The method of claim 14, substituting steps b-d by:
b. the request from said wireless telecommunication device is answered with a redirection address to a data operator operated by/for the broadcast network,
c. the application in said wireless telecommunication device sending a request directly to the determined operator, and
d. Sending a reply to the client application.
